(19) United States
(12) Patent Application Publication
(10) Pub. No.: US 2023/0391206 A1
(43) Pub. Date: Dec. 7, 2023

(54) MOTOR TORQUE-BASED VEHICLE ROLL STABILITY

(71) Applicant: Rivian IP Holdings, LLC, Irvine, CA (US)

(72) Inventors: Kevin Jared Sallee, Lake Forest, CA (US); Michael Fei-kit Tung, Irvine, CA (US); Werner Roland Naegeli, Costa Mesa, CA (US)

(21) Appl. No.: 17/832,150

(22) Filed: Jun. 3, 2022

(51) Int. Cl. B60L 15/20; B60W 10/08; B60W 30/04

(52) U.S. Cl. CPC B60L 15/2036; B60W 10/08; B60W 30/04; B60L 2240/22; B60W 2510/22; B60W 2510/20; B60W 2520/18; B60W 2520/28; B60W 2710/083; B60W 2520/105; B60W 2520/125; B60L 2240/423

(57) ABSTRACT

Roll stability for a vehicle is provided using motor torque adjustments to wheels of the vehicle. When a vehicle state indicative of an undesirable roll stability level is detected, a roll stability mode is activated. In response to activating the roll stability mode, motor torque to at least one wheel of the vehicle is adjusted independently of motor torque to other wheels of the vehicle.

### INTRODUCTION

Under certain driving conditions, a vehicle can experience an undesirable roll moment that can to lead to instability. This may occur, for instance, when a vehicle is steered sharply or collides with another vehicle or object. In some cases, the instability from a roll moment on a vehicle can result in wheel lift on one side of the vehicle or a rollover in which the vehicle tips or otherwise rolls onto its side or roof.

### SUMMARY

Embodiments of the present technology relate to, among other things, providing roll stability for a vehicle using motor torque. Based on sensor data from one or more sensors on a vehicle, a vehicle state is detected. The vehicle state may indicate that the vehicle has reached an undesirable roll stability level, and in some cases, is under conditions that could lead to, for example, a risk of wheel lift or rollover. Based on detecting the vehicle state, a roll stability mode is activated for the vehicle. In response to the roll stability mode being activated, motor torque provided to a wheel of the vehicle is adjusted independently of motor torque provided to other wheels of the vehicle. In some configurations, motor torque provided to a first wheel of the vehicle is increased, while motor torque provided to a second wheel of the vehicle is reduced. The first wheel and the second wheel may be on opposite sides of the vehicle. In further configurations, the first wheel and the second wheel may be on the same axle of the vehicle. The motor torque adjustment creates a yaw counter moment that reduces a yaw moment on the vehicle, which in turn reduces a lateral acceleration of the vehicle and provides roll stability for the vehicle.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIGS. 1A and 1B are plan views of a vehicle illustrating forces on a vehicle and providing roll stability for the vehicle using motor torque in accordance with some implementations of the present disclosure;

FIG. 2 is a plan view of a vehicle having a quad-motor arrangement that provides roll stability for the vehicle via motor torque in accordance with some implementations of the present disclosure;

FIG. 3 is a plan view of a vehicle having a tri-motor arrangement that provides roll stability for the vehicle via motor torque in accordance with some implementations of the present disclosure;

FIG. 4 is a flow diagram showing a method for detecting a vehicle state of a vehicle and providing roll stability for the vehicle using motor torque in accordance with some implementations of the present disclosure; and

FIG. 5 is a block diagram of an exemplary system for providing roll stability for a vehicle using motor torque in accordance with some implementations of the present disclosure.

### DETAILED DESCRIPTION

The technology described herein relates to providing roll stability for a vehicle using motor torque. In accordance with some aspects, motor torque to a wheel of a vehicle is separately controllable from motor torque to other wheels of the vehicle. For instance, a vehicle could be configured with a first motor providing motor torque to a first wheel and a second motor providing motor torque to a second wheel. Sensor data from one or more sensors on the vehicle may be used to detect a vehicle state of the vehicle that activates a roll stability mode for the vehicle. The vehicle state indicates that the vehicle has reached an undesirable roll stability level, and in some cases, may be approaching a situation in which there is, for example, a risk of wheel lift or rollover. The vehicle state may be based on any combination of different inputs, such as, for instance, lateral acceleration, longitudinal acceleration, steering inputs, ride heights, drive modes, and vehicle speed. In response to activating the roll stability mode, motor torque to a first wheel is adjusted independently from motor torque to a second wheel. In some configurations, the motor torque to a first wheel is increased, while motor torque to a second wheel is reduced. The motor torque adjustment introduces a yaw counter moment that reduces a yaw of the vehicle, thereby reducing the lateral acceleration of the vehicle and providing roll stability, which may, for example, mitigate a risk of wheel lift or rollover.

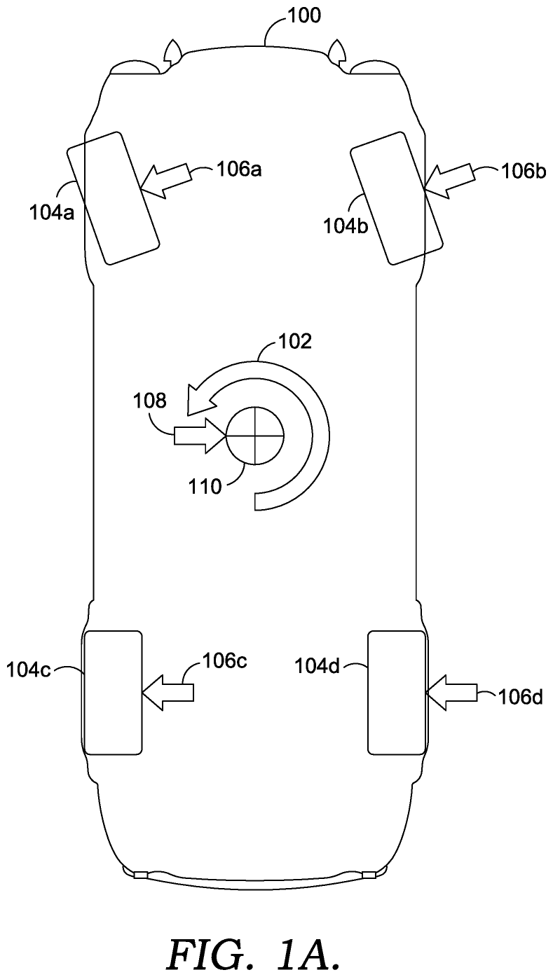

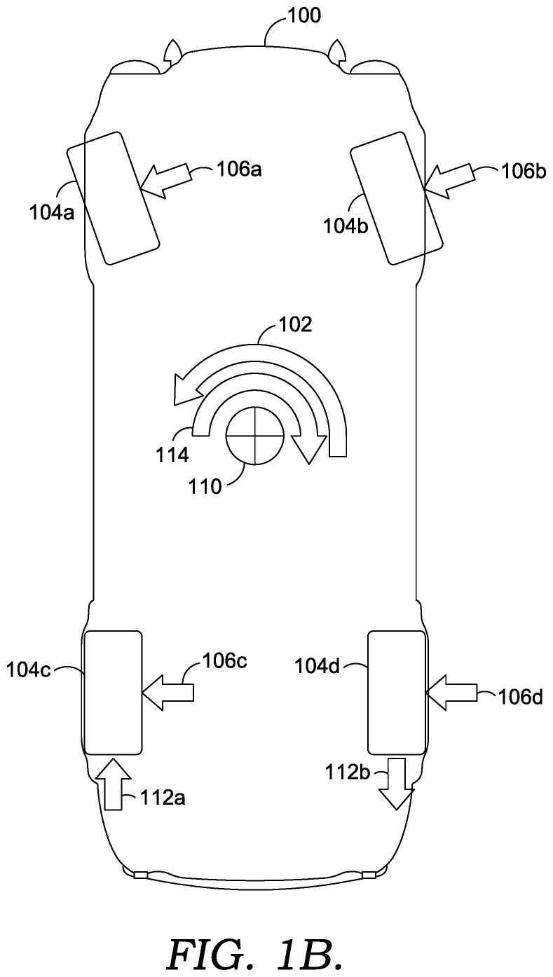

With reference now to the drawings, FIGS. 1A and 1B provide plan views of a vehicle 100 illustrating roll stability using motor torque in accordance with some aspects of the technology described herein. The vehicle 100 may be any type of wheeled vehicle, such as, for instance, a sedan, coupe, sports car, station wagon, hatchback, convertible, sport-utility vehicle, minivan, van, truck (light, medium, heavy, etc.), bus, golf cart, all-terrain vehicle (ATV), or recreation vehicle (RV), to name a few.

FIG. 1A illustrates a number of forces on the vehicle 100 that may contribute to a an undesirable roll stability level, and in some cases, could lead to, for example, a risk of wheel lift or a rollover of the vehicle 100. As shown in FIG. 1A, the vehicle 100 is subject to a yaw moment 102, causing rotation around a vertical axis of the vehicle 100. The yaw moment 102 may result, for instance, from a steered turn of the vehicle 100 or a collision of the vehicle 100 with another vehicle or object.

Contact of the wheels 104a-104d with a road or other surface causes lateral forces 106a-106d on the vehicle 100. The lateral forces 106a-106d, in conjunction with an opposing force 108 on the center of gravity 110 of the vehicle 100, creates a roll moment (not shown) around a horizontal axis of the vehicle. A height difference between the opposing force 108 and the lateral forces 106a-106d can impact the roll moment and the corresponding roll stability level. When sufficient depending on various aspects associated with the vehicle 100, the roll moment causes instability that could lead to, for example, a risk of wheel lift or rollover for the vehicle 100.

FIG. 1B illustrates use of motor torque to provide roll stability for the vehicle 100. When a vehicle state indicative of an undesirable roll stability level (e.g., conditions that could lead to a potential risk of wheel lift or rollover) is detected for the vehicle 100, a roll stability mode is activated. In the roll stability mode, motor torque to at least a portion of the wheels 104a-104d is adjusted. By way of example only and not limitation, FIG. 1B illustrates increasing motor torque to the left rear wheel 106c and reducing motor torque to the right rear wheel 106d. The motor torque adjustment creates a longitudinal force 112a at the left rear wheel 106c and an opposing longitudinal force 112b at the right rear wheel 106d. This creates a yaw counter moment 114 that reduces the yaw moment 102. The reduction in the yaw moment 102 reduces at least some of the lateral forces 106a-106d, which provides roll stability for the vehicle 100. In some cases, the roll stability can mitigate, for example, the risk of wheel lift or rollover for the vehicle 100.

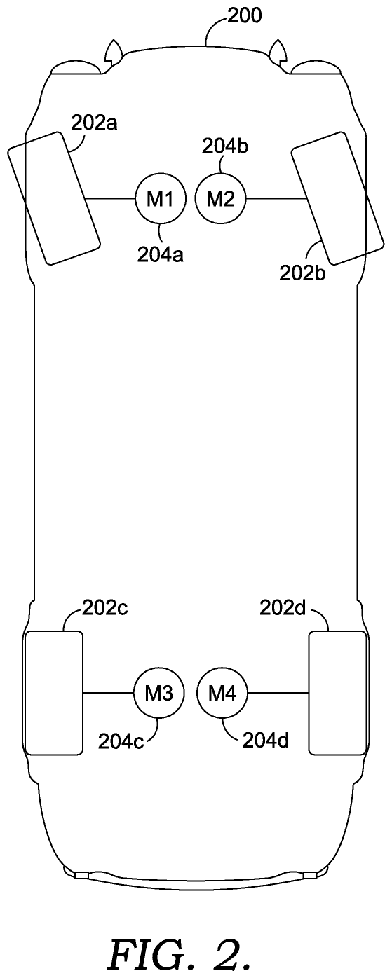

Aspects of the technology described herein are applicable to any configuration of a vehicle in which motor torque is individually controllable to at least a portion of the wheels on the vehicle. By way of example only and not limitation, FIG. 2 provides a plan view of a vehicle 200 having a quad-motor arrangement. The vehicle 200 may be any type of wheeled vehicle, such as, for instance, a sedan, coupe, sports car, station wagon, hatchback, convertible, sport-utility vehicle, minivan, van, truck (light, medium, heavy, etc.), bus, golf cart, all-terrain vehicle (ATV), or recreation vehicle (RV), to name a few.

As shown in FIG. 2, the vehicle 200 includes a left front wheel 202a, a right front wheel 202b, a left rear wheel 202c, and a right rear wheel 202d. The vehicle 200 also includes a first motor 204a providing motor torque to the left front wheel 202a, a second motor 204b providing motor torque to the right front wheel 202b, a third motor 204c providing motor torque to the left rear wheel 202c, and a fourth motor 204d providing motor torque to the right rear wheel 202d. Each of the motors 204a-204d may comprise any type of machine, such as a combustion engine or electric motor, that provides power and torque to corresponding wheels 202a-202d.

Because each wheel 202a-202d has a corresponding motor 204a-204, motor torque provided to each wheel 202a-202d is separately controllable by increasing or reducing torque from corresponding motors 204a-204d. In accordance with aspects of the technology described herein, when a vehicle state indicative of an undesirable roll stability level (e.g., conditions that could lead to a risk of wheel lift or rollover) is detected, motor torque to one or more of the wheels 202a-202d is adjusted to reduce yaw and provide roll stability.

In accordance with some aspects, motor torque adjustment for providing roll stability includes increasing motor torque to at least one of the wheels 202a-202d. As used herein, increasing motor torque to a wheel comprises increasing a forward torque (i.e., propulsive torque). For instance, if the vehicle 200 is subject to a counter-clockwise yaw moment, increasing the motor torque of the motor 204a to the left front wheel 202a and/or the motor torque of the motor 204c to the left rear wheel 202c can contribute to a clockwise yaw counter moment. In accordance with some aspects, motor torque adjustment includes reducing motor torque to at least one of the wheels 202a-202d. As used herein, reducing motor torque to a wheel comprises reducing a forward torque (i.e., propulsive torque) or applying a reverse torque (i.e., regenerative braking). For instance, if the vehicle 200 is subject to a counter-clockwise yaw moment, reducing the motor torque of the motor 204b to the right front wheel 202b and/or the motor torque of the motor 204d to the right rear wheel 202d can contribute to a clockwise yaw counter moment.

Any combination of motor torque adjustments of the motors 204a-204d to the wheels 202a-202d that produces a yaw counter moment can be employed within the scope of the technology described herein. In accordance with some aspects, motor torque to at least one wheel on one side of the vehicle 200 is increased, while motor torque to at least one wheel on the other side of the vehicle 200 is reduced. For instance, in the case of a counter-clockwise yaw moment on the vehicle 200, the motor torque of the motor 204a to the left front wheel 202a and/or the motor torque of the motor 204c to the left rear wheel 202c may be increased, while the motor torque of the motor 204b to the right front wheel 202b and/or the motor torque of the motor 204d to the right rear wheel 202d may be reduced. In some configurations, motor torque to wheels on different axles are adjusted. For instance, the motor torque adjustment could be an increase of the motor torque of the motor 204c to the left rear wheel 202c and a reduction of the motor torque of the motor 204b to the right front wheel 202b. In other configurations, motor torque to wheels on the same axle are adjusted. For instance, the motor torque adjustment could be an increase of the motor torque of the motor 204c to the left rear wheel 202c and a reduction of the motor torque of the motor 204d to the right rear wheel 202d. Some configurations may adjust motor torque to only non-steered wheels to prevent or reduce pull on the steering wheel and/or otherwise increase stability. For instance, in the example of FIG. 2, the front wheels 202a, 202b are steered, and the rear wheels 202c, 202d are non-steered. Accordingly, in some aspects, the motor torque to only the rear wheels 202c, 202d is adjusted for roll stability. In some configurations, the same amount of motor torque adjustment may be made to each wheel on opposing sides of the vehicle 200. For instance, the motor torque from the motor 204c to the left rear wheel 202c can be increased in a first amount, and the motor torque from the motor 204d to the right rear wheel 202d can be decreased in a second amount equal to the first amount. In other configurations, the amount of motor torque adjustment may differ for different wheels of the vehicle 200.

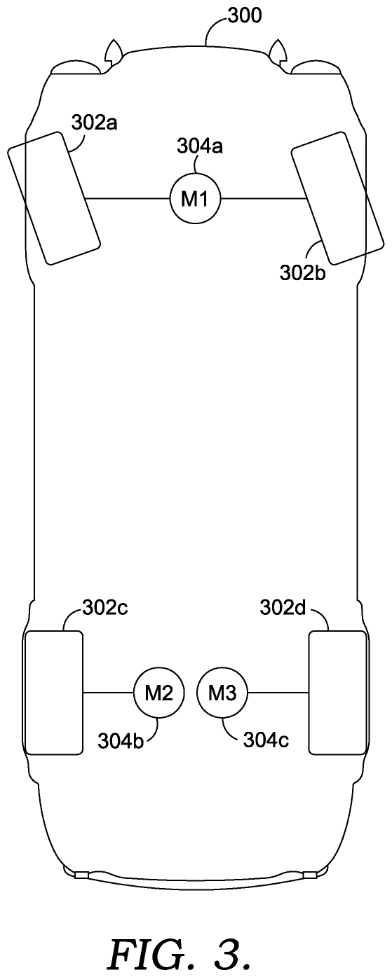

As an example of another configuration, FIG. 3 provides a plan view of a vehicle 300 having a tri-motor arrangement. The vehicle 300 may be any type of wheeled vehicle, such as, for instance, a sedan, coupe, sports car, station wagon, hatchback, convertible, sport-utility vehicle, minivan, van, truck (light, medium, heavy, etc.), bus, golf cart, all-terrain vehicle (ATV), or recreation vehicle (RV), to name a few.

As shown in FIG. 3, the vehicle 300 includes a left front wheel 302a, a right front wheel 302b, a left rear wheel 302c, and a right rear wheel 302d. The vehicle 300 also includes a first motor 304a providing motor torque to the left front wheel 302a and the right front wheel 302b, a second motor 304b providing motor torque to the left rear wheel 302c, and a third motor 304d providing motor torque to the right rear wheel 302d. Each of the motors 304a-304c may comprise any type of machine, such as a combustion engine or electric motor, that provides power and torque to corresponding wheels 302a-302d. Although not shown in FIG. 3, the vehicle 300 may include a differential that distributes power and motor torque from the motor 304a to the left front wheel 302a and the right front wheel 302b.

Similar to the discussion above for the vehicle 200, the motor torque to at least a portion of the wheels 302a-302d can be independently adjusted for roll stability by adjusting the motor torque provided by corresponding motors 304a-304c. By way of example only and not limitation, the motor torque of the motor 304b to the left rear wheel 302c can be increased, while the motor torque of the motor 304c to the right rear wheel 302d can be reduced. Other combinations of motor torque adjustments can be used to provide a yaw counter moment on the vehicle 300 and provide roll stability.

While FIGS. 2 and 3 provide examples of quad-motor and tri-motor arrangements, it should be understood that aspects of the technology described herein can be applied to vehicles having any number of motors in which motor torque is separately controllable for at least a portion of the wheels in order to produce a yaw counter moment for roll stability. Additionally, while the examples provided herein illustrate a vehicle with two axles and four wheels, with front steered wheels and rear non-steered wheels, it should be understood that aspects of the technology described herein apply to vehicles with any number of axles, any number of wheels, and different steered configurations.

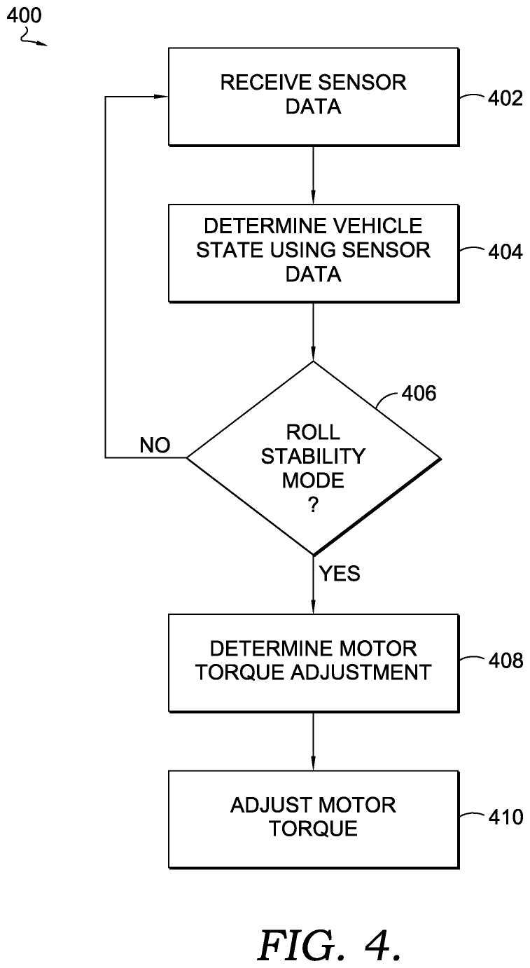

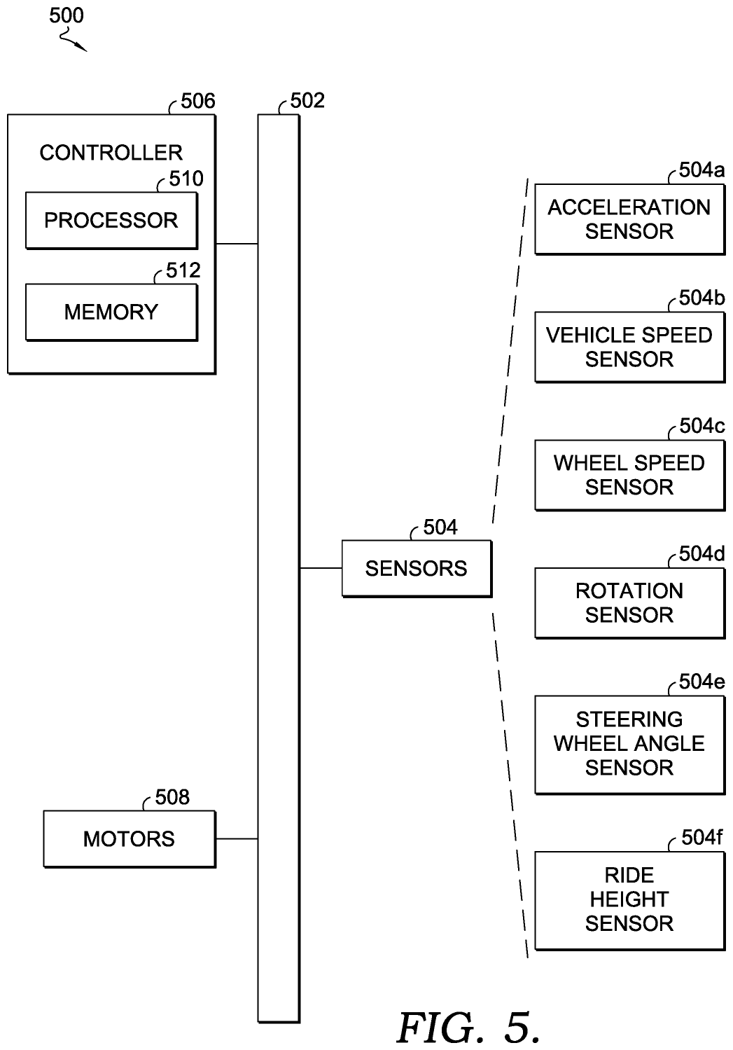

With reference now to FIG. 4, a flow diagram is provided that illustrates a method 400 for providing roll stability of a vehicle, such as the vehicle 100 of FIGS. 1A and 1B, the vehicle 200 of FIG. 2, or the vehicle 300 of FIG. 3. The method 400 can be performed at least in part, for instance, by the controller 506 of FIG. 5 discussed below. Some blocks of the method 400 and any other methods described herein comprise a computing processes performed using any combination of hardware, firmware, and/or software. For instance, various functions can be carried out by a processor executing instructions stored in memory. The methods can also be embodied as computer-usable instructions stored on computer storage media.

As shown at block 402, sensor data is received. The sensor data may be received from any number of different sensors on the vehicle, such as the sensors 504 described below with reference to FIG. 5. The sensor data received at block 402 includes data useful for determining a vehicle state indicative of roll stability level (e.g., the extent to which the vehicle is under conditions that could lead to a risk of wheel lift or rollover for the vehicle). By way of example only and not limitation, the sensor data may include lateral acceleration, longitudinal acceleration, steering wheel inputs (e.g., steering wheel angle), vehicle speed, yaw, roll, pitch, ride height, and/or drive mode (which may be based on a number of different factors, such as ride height, suspension stiffness, accelerator pedal response, stability control, all-wheel drive, etc.).

A vehicle state of the vehicle is determined using the sensor data, as shown at block 404. The vehicle state represents physical properties of the vehicle indicative of whether the vehicle has reached an undesirable roll stability level and may be under conditions that could lead to, for example, a risk of wheel lift or rollover. In some configurations, a roll stability level, yaw rate threshold, or other attribute of the vehicle state may be determined based on the configuration of the particular vehicle or using machine learning techniques applied to, for instance, the driver's historical driving behavior, or the driving behavior of other drivers having a similar profile as the driver, and as stored in memory of the vehicle or a server associated with the vehicle manufacturer. A determination is made regarding whether to activate a roll stability mode based on the vehicle state, as shown at block 406.

The roll stability mode may be activated based on a variety of different vehicle states in accordance with aspects of the technology described herein. By way of example only and not limitation, in some cases, the roll stability mode may be activated based on the vehicle having a yaw rate exceeding a threshold yaw rate. The threshold yaw rate may be variable based on other properties, such as vehicle speed and ride height. For instance, the threshold yaw rate may decrease as vehicle speed increases and/or ride height increases. In some cases, the roll stability mode may be activated based on the vehicle having a lateral acceleration exceeding a threshold lateral acceleration. The threshold lateral acceleration may also be variable based on other properties, such as vehicle speed and ride height. In further configurations, activation of the roll stability mode may be based on the steering wheel angle and vehicle speed. In still further configurations, the roll stability mode may be activated based on data from a roll sensor indicating a roll rate of the vehicle.

In some aspects, the roll stability mode may not be activated under certain conditions. For instance, in some configurations, the roll stability mode may not be activated if the vehicle speed is below a certain threshold. This reflects that a vehicle is not subject to an undesirable roll stability level, such as conditions that could lead to, for instance, a risk of wheel lift or rollover, regardless of yaw rate when the vehicle is under a certain speed. As another example, the roll stability mode may not be activated when the ride height is below a threshold setting. This reflects that a vehicle is less subject to an undesirable roll stability level when the center of gravity height of the vehicle is lowered.

If the roll stability mode is not activated, the process returns to block 402 and continues to monitor sensor data to determine if a vehicle state is encountered that triggers the roll stability mode. Alternatively, if the roll stability mode is activated, motor torque adjustment to one or more wheels of the vehicle is determined, for instance, by one or more electric control units (ECU), as shown at block 408. The motor torque adjustment may be determined in a variety of different manners. In some configurations, the motor torque adjustment is determined using the same sensor data used to determine the vehicle state that triggered activation of the roll stability mode. This sensor data could include lateral acceleration, longitudinal acceleration, steering wheel inputs (e.g., steering wheel angle), vehicle speed, yaw, roll, pitch, ride height, and/or drive mode. For instance, the motor torque adjustment may be based on the vehicle state determined at block 404. In other configurations, the motor torque adjustment is determined using different sensor data and/or physical properties of the vehicle.

In accordance with some aspects of the technology described herein, the process determines a motor torque adjustment to one or more wheels of the vehicle to provide a yaw counter moment that reduces the yaw moment on the vehicle, thereby reducing the lateral acceleration of the vehicle and providing roll stability. Motor torque adjustments may be made to various combinations of wheels. In some instances, motor torque to at least one wheel may be increased by sending instructions from a central processing unit of the vehicle to one or more ECUs (e.g., Vehicle Dynamics Module) of the vehicle to control the motor torque accordingly. As indicated previously, increasing motor torque comprises increasing a forward torque (i.e., propulsive torque). In some instances, motor torque to at least one wheel may be reduced. As indicated previously, reducing motor torque comprises reducing a forward torque (i.e., propulsive torque) or applying a reverse torque (i.e., regenerative braking). In some configurations, motor torque to a wheel on one side of the vehicle is increased, while motor torque to a wheel on the other side of the vehicle is reduced. The wheels may be on the same axle or different axles. Additionally, the wheels may be steered or non-steered. In some configuration, motor torque is adjusted only for non-steered wheels on the same axle. For instance, the wheels on the rear axle of a vehicle may be non-steered, and the motor torque adjustments may comprise increasing motor torque to one rear wheel while reducing motor torque to the other rear wheel. Adjusting motor torque to non-steered wheels on the same axle can reduce or eliminate pull on the steering wheel and provide better stability.

The amount of motor torque adjustment for each wheel of a vehicle can be determined in a number of different ways within the scope of the technology described herein. By way of example only and not limitation, motor torque adjustment may be based on an algorithm that calculates an amount of motor torque adjustment given sensor data and/or other data regarding physical properties of the vehicle. The algorithm may be based at least in part on the bicycle model and could employ input factors, such as vehicle wheel base, lateral acceleration, center of gravity height, steering wheel angle, front wheel road angle, vehicle mass, vehicle speed, and yaw rate.

In some configurations, the amount of motor torque adjustment for each wheel may be determined using a lookup table. By way of example and not limitation, a lookup table may have lateral acceleration or yaw rate values along one axis, vehicle speed along the other axis, and a motor torque adjustment in each cell. When a vehicle state is determined from sensor data indicating a given lateral acceleration or yaw rate and a vehicle speed, a cell of the table corresponding with that lateral acceleration or yaw rate and vehicle speed is accessed to retrieve a motor torque adjustment to one or more wheels of the vehicle.

As shown at block 410, motor torque to at least one wheel of the vehicle is adjusted based on the motor torque adjustment determined at block 408. This may include increasing motor torque of a first motor to a first wheel of the vehicle and/or reducing motor torque of a second motor to a second wheel of the vehicle.

Turning next to FIG. 5, a block diagram is provided illustrating an exemplary system 500 for providing roll stability for a vehicle in accordance with some implementations of the present disclosure. As shown in FIG. 5, the system 500 includes a bus 502 that directly or indirectly couples, among other components not shown, sensors 504, controller 506, and motors 508. Bus 502 represents what can be one or more vehicle communication buses, such as, for instance, a Controller Area Network (CAN) bus, a FlexRay bus, and/or an Ethernet bus. It should be understood that this and other arrangements described herein are set forth only as examples. Other arrangements and elements can be used in addition to or instead of those shown, and some elements can be omitted altogether.

The system 500 includes any number of sensors 504 that provide input to the controller 506. Each of the sensors 504 can comprise one or more gyroscopes, accelerometers, inertial measurement units (IMUs), magnetic devices, optical devices, voltage devices, or other devices that detect and measure a physical property associated with the vehicle. As shown in FIG. the sensors 504 can include one or more of: an acceleration sensor 504a, a vehicle speed sensor 504b, a wheel speed sensor 504c, a rotation sensor 504d, a steering wheel angle sensor 504e, and a ride height sensor 504f. The sensors 504a-504f shown in FIG. 5 are provided by way of example only and not limitation. Some of the sensors shown can be omitted and other sensors not shown included in accordance with various aspects of the technology described herein.

The acceleration sensor 504a provides data regarding acceleration of the vehicle in one or more directions, such as for example, a lateral acceleration of the vehicle and/or a longitudinal acceleration of the vehicle. The vehicle speed sensor 504b provides an indication of the speed of the vehicle. The wheel speed sensor 504c provides a speed of rotation for a wheel of the vehicle. Each wheel on the vehicle may have a corresponding wheel speed sensor 504c. The rotation sensor 504d provides data regarding the vehicle's rotation (e.g., angular rate) around one or more of its axes. The rotation sensor 504d may comprise, for instance, a yaw sensor providing data regarding the vehicle's rotation around a vertical axis of the vehicle. The rotation sensor 504d may also comprise a roll sensor and/or a pitch sensor providing data regarding the vehicle's rotation around a horizontal axis of the vehicle. The steering wheel angle sensor 504e provides data regarding the steering wheel's rate of turn, angle (i.e., extent to which the steering wheel has been turned), and/or other data associated with the steering wheel (and the corresponding steered wheels). The ride height sensor 504f provides data associated with a height of the base/low point of the vehicle relative to the ground. In the case of a vehicle with a fixed number of ride height settings, the ride height sensor 504f may provide an indication of the vehicle's current ride height setting.

The controller 506 generally operates to receive sensor data from the sensors 504, detect a vehicle state indicative of an undesirable roll stability level (e.g., conditions that could lead to a risk of wheel lift or rollover), determine motor torque adjustments, and control the motors 508 to adjust motor torque. While only a single controller 506 is shown in FIG. 5, it should be understood that aspects of the technology described herein could include any number of controllers, which may also comprise one or more electronic control units (ECU) configured to send instructions for controlling the behavior of one or more physical components of the vehicle. For instance, a separate controller 506 could be provided for controlling each motor 508.

As shown in FIG. 5, the controller 506 may comprise a processor 510 and memory 512. While the controller 506 is shown with a single processor 510 and a single memory 512, it should be understood that the controller 506 can include any number of processors and memory. The processor 510 may comprise any type of special-purpose or general-purpose processor. The memory 512 includes computer storage media in the form of volatile and/or nonvolatile memory. The memory 512 may be removable, non-removable, or a combination thereof. Exemplary hardware devices for the memory 512 include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store desired information and which can be accessed by the system 500. The memory 512 does not comprise signals per se. The processor 510 can read data from various entities such as the memory 512 and/or the sensors 504. In some instances, the memory 512 stores computer-usable instructions that are read by the processor 510 to perform functions described herein. The processor 510 and memory 512 can be separate or integrated components. Illustrative types of hardware logic components that can be used for the controller 506 include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Each of the motors 508 may comprise any type of machine, such as a combustion engine or electric motor, that provides power and torque to corresponding wheels of the vehicle. Any number of motors 508 can be provided within the scope of embodiments of the technology described herein. Each of the motors 508 may be connected to one or more wheels.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

Components can be configured for performing novel embodiments of the technology described herein, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the advantages set forth herein, together with other advantages which are inherent to the disclosed technology. It will be understood that certain features and subcombinations are of utility and can be employed without reference to other features and subcombinations. This is contemplated by and is within the scope of the claims.

What is claimed is:

1. A method for providing roll stability of a vehicle, the method comprising:
detecting a vehicle state of the vehicle based on received sensor data;
activating a roll stability mode based on the vehicle state; and
in response to activating the roll stability mode:
increasing motor torque to a first wheel of the vehicle; and
reducing motor torque to a second wheel of the vehicle.

2. The method of claim 1, wherein the first wheel is on a first side of the vehicle and the second wheel is on a second side of the vehicle opposite the first side of the vehicle.

3. The method of claim 2, wherein the first wheel and the second wheel are on a same axle of the vehicle.

4. The method of claim 1, wherein the motor torque to the first wheel is increased a first amount and the motor torque to the second wheel is reduced in a second amount equal to the first amount.

5. The method of claim 1, wherein increasing the motor torque to the first wheel comprises increasing a forward torque to the first wheel.

6. The method of claim 1, wherein reducing the motor torque to the second wheel comprises providing a reverse torque to the second wheel.

7. The method of claim 1, wherein the sensor data comprises one or more selected from the following: lateral acceleration, longitudinal acceleration, steering wheel input, vehicle speed, yaw, roll, pitch, ride height, and drive mode.

8. The method of claim 1, wherein the motor torque to the first wheel is increased in a first amount and the motor torque to the second wheel is reduced in a second amount, and wherein the first amount and the second amount are determined based on one or more selected from the following: lateral acceleration, longitudinal acceleration, steering wheel input, vehicle speed, yaw, roll, pitch, ride height, and drive mode.

9. One or more computer storage media storing computer-usable instructions that, when used by one or more processors, cause the one or more processors to perform operations, the operations comprising:
receiving sensor data from one or more sensors on a vehicle;
detecting a vehicle state of the vehicle using the sensor data;
activating a roll stability mode for the vehicle based on detecting the vehicle state; and
causing a motor torque adjustment to one or more wheels of the vehicle in response to activating the roll stability mode.

10. The one or more computer storage media of claim 9, wherein the sensor data comprises one or more selected from the following: lateral acceleration, longitudinal acceleration, steering wheel input, vehicle speed, yaw, roll, pitch, ride height, and drive mode.

11. The one or more computer storage media of claim 9, wherein causing the motor torque adjustment to one or more wheels of the vehicle in response to activating the roll stability mode comprises causing an increase in forward torque to a first wheel of the vehicle.

12. The one or more computer storage media of claim 11, wherein causing the motor torque adjustment to one or more wheels of the vehicle in response to activating the roll stability mode further comprises reducing motor torque to a second wheel of the vehicle.

13. The one or more computer storage media of claim 12, wherein reducing motor torque to the second wheel comprises providing a reverse torque to the second wheel.

14. The one or more computer storage media of claim 12, wherein the first wheel is on a first side of the vehicle and the second wheel is on a second side of the vehicle opposite the first side of the vehicle.

15. The one or more computer storage media of claim 14, wherein the first wheel and the second wheel are on a same axle of the vehicle.

16. A vehicle comprising:
a first wheel;
a second wheel;
a first motor connected to the first wheel;
a second motor connected to the second wheel;
one or more sensors; and
a controller configured to:
detect, based on sensor data from the one or more sensors, a vehicle state indicative of roll stability of the vehicle; and
in response to detecting the vehicle state, cause the first motor to increase motor torque to the first wheel and the second motor to reduce motor torque to the second wheel.

17. The vehicle of claim 16, wherein the one or more sensors comprise one or more selected from the following: an acceleration sensor, a vehicle speed sensor, a wheel speed sensor, a rotation sensor, a steering wheel angle sensor, and a ride height sensor.

18. The vehicle of claim 16, wherein the first wheel is on a first side of the vehicle and the second wheel is on a second side of the vehicle opposite the first side of the vehicle.

19. The vehicle of claim 18, wherein the first wheel and the second wheel are on a same axle of the vehicle.

20. The vehicle of claim 16, wherein in response to detecting the vehicle state, the controller causes the first motor to increase a forward torque to the first wheel and the second motor to provide a reverse torque to the second wheel.
